(19) United States
(12) Patent Application Publication
(10) Pub. No.: US 2011/0085318 A1
(43) Pub. Date: Apr. 14, 2011

(54) CHEMILUMINESCENT SIGNALING DEVICES

(76) Inventors: Earl CRANOR, Longmeadow, MA (US); Eric DOMINGOS, Chicopee, MA (US)

(21) Appl. No.: 12/856,091

(22) Filed: Aug. 13, 2010

Related U.S. Application Data
(60) Provisional application No. 61/234,593, filed on Aug. 17, 2009.

(51) Int. Cl. F21K 2/06

(52) U.S. Cl. 362/34

(57) ABSTRACT

A signaling device comprising a multi-part chemiluminescent light source and a reflective member attached to the signaling device. The chemiluminescent light source comprises at least one first part comprising at least one oxalate ester and at least one fluorescer, and at least one second part comprising at least one peroxide and at least one catalyst. Further, the signaling device comprises a multi-part chemiluminescent light source and a stand attached to the signaling device, wherein the chemiluminescent light source comprises at least one first part comprising at least one oxalate ester and at least one fluorescer, and at least one second part comprising at least one peroxide and at least one catalyst.

The present disclosure relates to signaling devices for use in emergency situations, such as situations where light is needed in order to alert, advise caution, or indicate the presence of hazards or obstacles. More particularly, the present disclosure concerns markers and signal devices comprising a chemiluminescent system that allows the markers to emit light and be visible to others during emergencies, without the drawbacks of using ignition-based signaling devices.

Signaling devices, such as, for example, road flares, are used by the general population, the military, and the police during emergency situations, to visually identify a certain location, or to alert bystanders and others to the presence of a certain hazard or situation. Police officers and the general population typically use road flares following a car or road side accident. At an incident, such as a traffic accident, an individual typically distributes a plurality of road flares on the road as a temporary divider from the rest of the traffic, and as a way to alert other drivers of the accident. This allows other drivers to avoid driving too close to the accident and allows them to adjust their driving speed accordingly.

There are, however, a number of drawbacks in the use of the most common types of road flares. Road flares typically act by way of pyrotechnic combustion, wherein oxidants and fuels react to generate a flame. These ignition type flares can produce an open flame and burn at a temperature of more than 1000° F. Typically, this type of disposable flare is ignited and directly disposed on the roadway. Since the flare must be held by a user, such as a police officer, there is a possibility of a burn to the user or his or her clothes while the user holds the burning flare. The temperature at which the open flame burns causes these flares to be inherently dangerous, and can accidently burned even trained professionals. Some states have even banned the use of ignition type road flares due to the danger of the flares causing brush fires in very dry regions. In addition, the flare may damage the surface of the roadway when the flare is placed thereon since the heat produced by the flare may melt or scar the roadway and the residue of the flare will remain on the roadway when the flare is used.

The ignition type flare, after it is burnt out, may also expel perchlorates (ClO₄), which are very soluble in water. These perchlorates may contaminate drinking water and, when ingested by humans, may adversely affect thyroid glands and the ability to absorb iodine from the blood stream. These perchlorates may also be even more dangerous for children and fetuses and are regulated by multiple states. Finally, the usable time of the flare depends on the burning rate of the flare, therefore, if a policemen finishes their duty before the flare is used up, the flare must be left on the roadway until the flare is totally consumed.

There is therefore a need for a safer, non toxic form of signaling device. It is accordingly an object of the present disclosure to provide a chemiluminescent signaling device that emits a visible light and is safer than commonly employed road flares. This can be achieved by employing a chemiluminescent system within a signaling device, that can emit light upon activation. The chemiluminescent system comprises, for example, at least one first part comprising at least one oxalate ester and at least one fluorescer, and at least one second part comprising at least one peroxide and at least one catalyst.

Generally, the present disclosure provides signaling devices comprising a self contained light source wherein the devices emit light upon activation and methods of using such signaling devices. More specifically, chemiluminescent signaling devices are provided with a reflector and/or stand attached, wherein light is emitted upon activation of a chemiluminescent system, can be projected 360° from the device, and can be identifiable where it is deployed. With the signaling devices of the present disclosure, a plurality of devices can be quickly activated and deployed safely in an emergency situation.

One aspect of the disclosure is a signaling device with a self contained light source, such as, for example, a chemiluminescent light source, with a reflective member attached for improved visibility, wherein the reflective member can transmit light from head lamps or external light sources back to the source to further improve the visibility of the signaling device.

In another aspect of the disclosure, the light emitting chemiluminescent system comprised within the signaling device is non-flammable. In this aspect, the device will not produce a spark or flame in hazardous spills or in dry environmental conditions, and also can not burn the police officer or user. Another aspect of the disclosure includes the signaling device being non-toxic.

In another aspect of the disclosure, the signaling device can be waterproof. This embodiment allows the device to be used safely over water or in water, and improves the shelf life of the signaling device as compared to ignition type flares. Another aspect of the disclosure includes the signaling device that is maintenance free for the duration of its shelf life and use. Another aspect of the disclosure is that the signaling device can be produced without expensive or complicated structures. Therefore, the signaling device of the present disclosure provides an economic and efficient manner of alerting, advising caution, or indicating the presence of hazards or obstacles.

Another aspect of the disclosure is a signaling device with a self contained light source, such as, for example, a chemiluminescent light source with a reflector and a metal or plastic stand attached, wherein the stand can be deployed to allow the signaling device to sit upright on a surface, or can be oriented and used as a spike to allow the signaling device to be stuck into the ground. In another aspect of the disclosure, using the attached stand, the signaling device can be placed on traffic cones, which would burn and or melt if an ignition type flare was used.

Another aspect of the disclosure is a signaling device with a self contained light source, such as, for example, a chemiluminescent light source, with a reflector attached, wherein two or more signaling devices can be connected together at either end. In this aspect of the disclosure, the connection requires no additional parts, allows different colors of lights to be connected together for different signaling purposes, and allows the size of the signaling device to be increased via the addition of more devices.

Accordingly, in certain embodiments the disclosure provides a signaling device with a self contained light source, such as, for example, a chemiluminescent light source, comprising a reflector attached for improved visibility, an illumination unit comprised of a chemiluminesent source of light, and a metal or plastic stand attached.

Additional objects and advantages of the disclosure will be set forth in part in the description which follows, and in part will be obvious from the description, or may be learned by practice of the disclosure. The objects and advantages of the present disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 illustrates the scenario wherein the use of a signaling device comprising a chemiluminescent light source would be desired, wherein a road flare with a reflector attached would be deployed for improved visibility at night for forming a temporary divider on a roadway.

FIG. 2 illustrates the use of a signaling device with a self contained light source, and more particularly a chemiluminescent light source with a reflector attached for improved visibility at night.

FIG. 3 is a perspective view of a signaling device with a self contained light source, and more particularly a chemiluminescent light source, with a reflector attached for improved visibility at night.

FIG. 4 is an exploded view of a signaling device with a self contained light source, and more particularly a chemiluminescent light source, with a reflector attached.

FIG. 5 is a section view of a signaling device with a self contained light source, and more particularly a chemiluminescent light source, with a reflector attached.

FIG. 6 is an illustration of a signaling device with a self contained light source, and more particularly a chemiluminescent light source, with a reflector and stand attached with legs deployed.

FIG. 7 illustrates the use of a signaling device with a self contained light source, and more particularly a chemiluminescent light source, with a reflector and stand attached displayed in a off road or soft ground situation, wherein the stand is used as a stake.

FIG. 8 illustrates the use of a signaling device with a self contained light source, and more particularly a chemiluminescent light source, with a reflector attached, displayed as a road flare on a 36″ traffic cone.

FIG. 9 illustrates the use of a signaling device with a self contained light source, and more particularly a chemiluminescent light source, with a reflector attached, with a second device attached longitudinally.

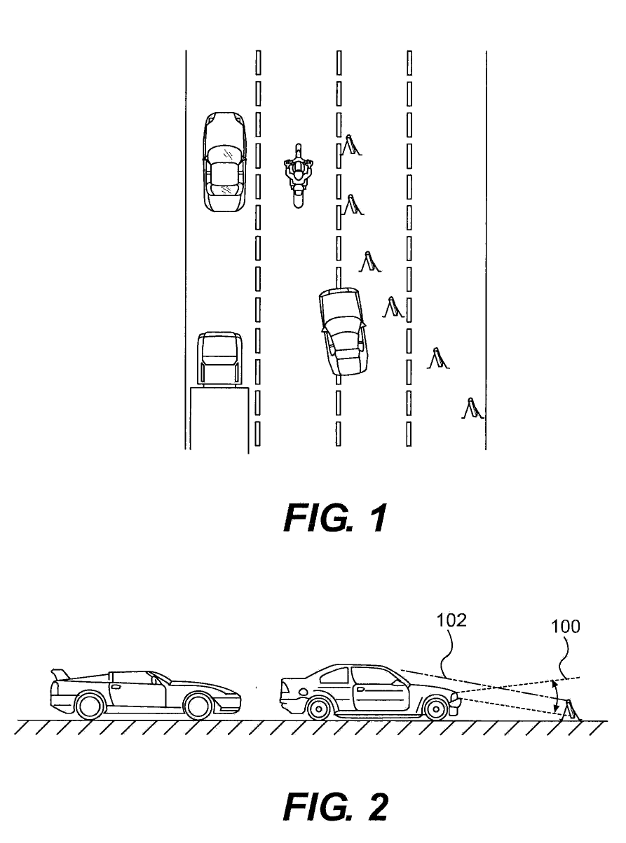

### DESCRIPTION OF THE EMBODIMENTS FIGS. 1 through 9 generally illustrate a signaling device with a self contained light source, such as, for example, a chemiluminescent light source, with a reflector attached for improved visibility, wherein the portable 360° light source arrangement is capable of functioning as a road flare to form a temporary divider on a roadway. FIG. 1 illustrates an example of using the signaling devices of the disclosure, wherein cars are alerted to the presence of an incident and diverted using a plurality of signaling devices.

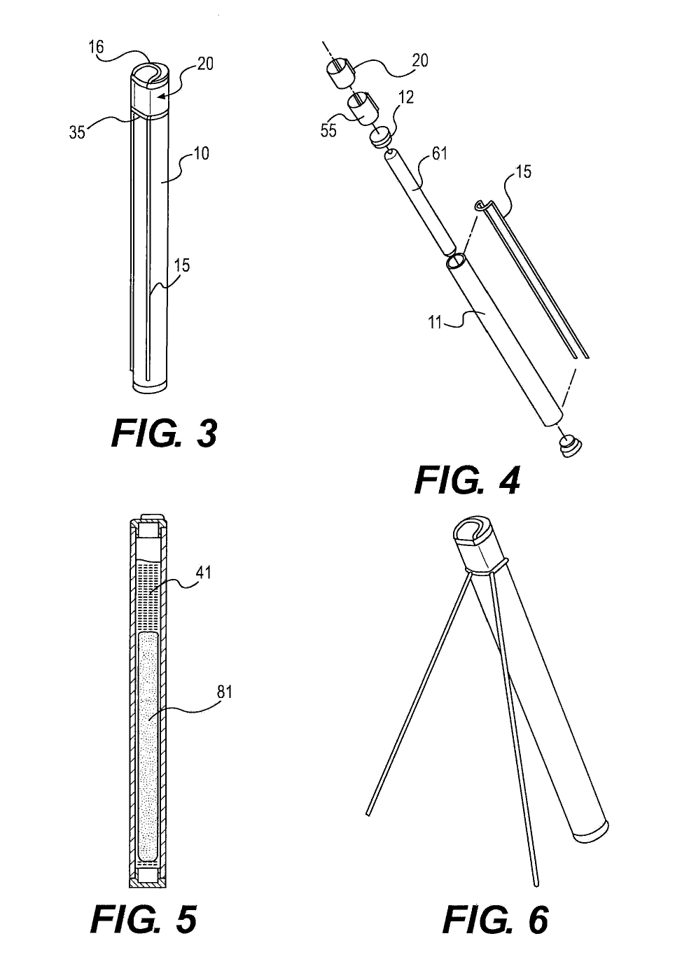

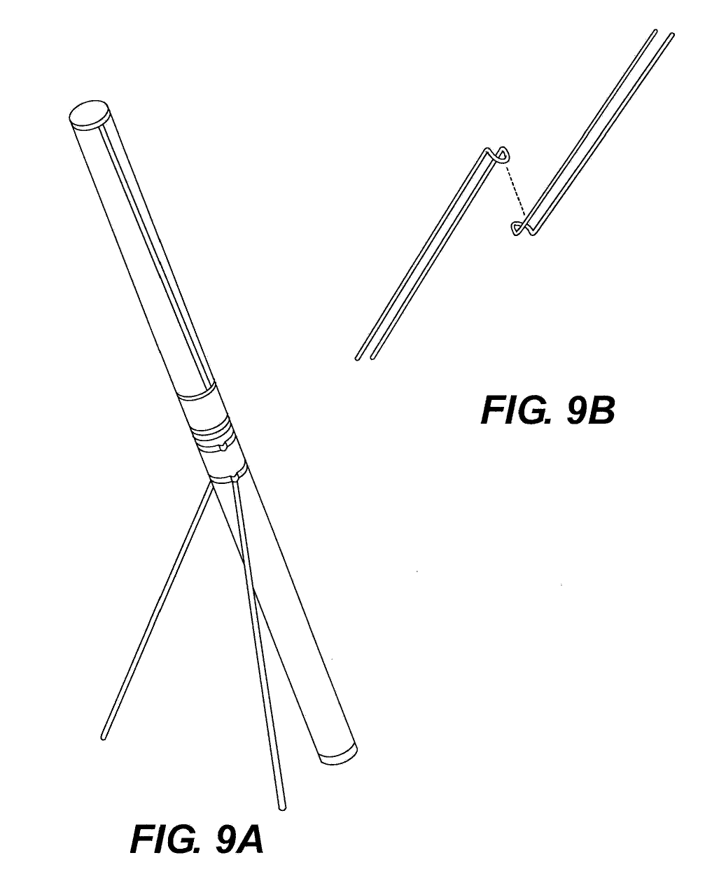

FIG. 3, illustrates a signaling device with a self contained light source, such as, for example, a chemiluminescent light source, with a reflector 20 attached for improved visibility. The signaling device 10 may be comprised of a chemiluminescent system, wherein a stand 15 is placed longitudinally against the signaling device 10, wherein an attachment member 55 is placed over the closed end of the stand 15 and axially over the signaling device 10 to secure the two in order to be self contained therein, and the reflector 20 is applied coaxially to the attachment member 55 and signaling device 10. The signaling device as illustrated in FIG. 3, also comprises an attachment feature 16 which allows, in one aspect of the disclosure, multiple signaling devices to be attached together, as illustrated in FIG. 9. The stand may be made of any suitable material to allow the stand to support the weight of the signaling device, as known to one of ordinary skill in the art, including metal or plastic stands. The metal or plastic stand can be attached by at least one of the following methods, chosen from molding, extruding, welding, heat staking, bent wire, adhesive, rubber band, shrink tubing, glue, vibratory welding, sonic welding, and vinyl tubing.

The reflector 20, may be comprised of at least one material chosen from metallic polyester tape, mirrors, retroreflective pismatics, retroreflective glass beads, and holographic materials. FIG. 2 illustrates what occurs when the light from a vehicle's head lamps 100 contacts the reflector 20 and returns light to viewers sight line 102. A reflector attached to the signaling device of the disclosure therefore has the advantage of increased visibility by approaching cars. Therein a chemiluminescent signaling device with a reflective member will have improved utility over the traditional road flare wherein the reflector can provide a secondary source of light and signaling, after the primary chemiluminescent light runs out, as the duration of the emergency is usually unknown.

As illustrated in FIG. 4, the signaling device 10 which provides illumination can be comprised of a flexible tube 11, a glass ampoule 61, and cap(s) 12, to hermetically enclose the chemiluminescent fluid. The chemiluminescent fluid may comprise a multi-part system that is comprised of at least two parts, maintained separately until activation. At least one component is located within the glass ampoule 61, and optionally one component exterior to the glass ampoule 61, within the flexible tube 11. To activate the signaling device, the user bends the flexible tubing, causing the glass ampoule to break and allowing the components of the multipart chemiluminescent system to interact. The components are then mixed when the user shakes the signaling device, and the interaction of the chemiluminescent components causes the emission of light. “Activation” as used herein means that a chemical reaction between the multiple components has started.

In one aspect of the disclosure, the first part of the multipart system is comprised of at least one oxalate ester and at least one fluorescer, and the second part is comprised of at least one peroxide and at least one catalyst. The first and second parts of the marking system may optionally comprise at least one carrier. The individual selection of suitable oxalate esters, fluorescers, peroxides, catalysts, and carriers is based on the desire to create visible, lasting light.

Examples of the at least one oxalate useful in the present disclosure include bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2-nitrophenyl)oxalate; bis(2,4-dinitrophenyl)oxalate; bis(2,6-dichloro-4-nitrophenyl) oxalate; bis(2,4,6-trichlorophenyl)oxalate; bis(3-trifluoromethyl-4-nitrophenyl)oxalate; bis(2-methyl-4,6-dinitrophenyl)oxalate; bis(1,2-dimethyl-4,6-dinitrophenyl)oxalate; bis(2,4-dichlorophenyl)oxalate; bis(2,4-dinitrophenyl)oxalate; bis(2,5-dinitrophenyl)oxalate; bis(2-formyl-4-nitrophenyl)oxalate; bis(pentachlorophenyl)oxalate; bis(1,2-dihydro-2-oxo-1-pyridyl)glyoxal; bis(2,4-dinitro-6-methylphenyl)oxalate; bis-N-phthalimidyl oxalate; and mixtures thereof.

Examples of the at least one fluorescer useful in the present disclosure include 1-methoxy-9,10-bis(phenylethynyl) anthracene, perylene, rubrene, 16,17-didecycloxyviolanthrone, 2-ethyl-9,10-bis(phenylethynyl)anthracene; 2-chloro-9,10-bis(4-ethoxyphenyl)anthracene; 2-chloro-9,10-bis(4-methoxyphenyl)anthracene; 9,10-bis(phenylethynyl)anthracene; 1-chloro-9,10-bis(phenylethynyl)anthracene; 1,8-dichloro-9,10-bis(phenylethynyl)anthracene; 1,5-dichloro-9,10-bis(phenylethynyl)anthracene; 2,3-dichloro-9,10-bis(phenylethynyl)anthracene; 5,12-bis(phenylethynyl)tetracene; 9,10-diphenylanthracene; 1,6,7,12-tetraphenoxy-N,N′-bis(2,6-diisopropylphenyl)-3,4,9,10-perylene dicarboximide; 1,6,7,12-tetraphenoxy-N,N′-bis(2,5-di-t-butylphenyl)-3,4,9,10-perylene dicarboximide; 1,7-di-chloro-6,12-diphenoxy-N,N′-bis(2,6-diisopropylphenyl)-3,4,9,10-perylene dicarboximide; 1,6,7,12-tetra(p-bromophenoxy)-N,N′-bis(2,6-diisopropylphenyl)-3,4,9,10-perylene dicarboximide; 1,6,7,12-tetraphenoxy-N,N′-di-neopentyl-3,4,9,10-perylene dicarboximide; 1,6,7,12-tetra(p-t-butylphenoxy)N,N′-dineopentyl-3,4,9,10-perylene dicarboximide; 1,6,7,12-tetra(o-chlorophenoxy)-N,N′-bis(2,6-diisopropylphenyl)-3,4,9,10-perylene dicarboximide; 1,6,7,12-tetra(p-chlorophenoxy)-N,N′-bis(2,6-diisopropylphenyl)-3,4,9,10-perylene dicarboximide; 1,6,7,12-tetra(o-fluorophenoxy)-N,N′-bis(2,6-diisopropylphenyl)-3,4,9,10-perylene dicarboximide; 1,6,7,12-tetra(p-fluorophenoxy)-N,N′bis(2,6-diisopropylphenyl)-3,4,9,10-perylene dicarboximide; 1,6,7,12-tetraphenoxy-N,N′-diethyl-3,4,9,10-perylene dicarboximide; 1,7-dibromo-6,12-diphenoxy-N,N′-bis(2-isopropylphenyl)-3,4,9,10-perylene dicarboximide; 16,17-dihexyloxyviolanthrone; rubrene; 1,4-dimethyl-9,10-bis(phenylethynyl)anthracene; and mixtures thereof.

The amount of oxalate and fluorescer employed is upwardly limited only by the solubility of the ester and fluorescer in the solvent chosen. However, as would be appreciated by one in the art, the efficiency of the reaction would decrease at certain high concentrations. In certain embodiments, the at least one oxalate is present in an amount ranging from 3 percent to 60 percent by weight, based on the total weight of the two-part composition. For example, the at least one oxalate can be present in an amount ranging from 3 percent to 50 percent by weight, based on the total weight of the two-part composition, such as from 3 percent to 40 percent by weight, from 3 percent to 30 percent by weight, from 5 percent to 25 percent by weight, and from 7 percent to 25 percent by weight. In certain embodiments, the at least one fluorescer is present in an amount ranging from 0.05 percent to 0.9 percent by weight based on the total weight of the two-part composition. For example, the at least one fluorescer can be present in an amount ranging from greater than 0.05 percent by weight to 0.9 percent by weight, based on the total weight of the two-part composition, such as from greater than 0.1 percent by weight, from greater than 0.2 percent by weight, from greater than 0.3 percent by weight, from greater than 0.4 percent by weight, from greater than 0.5 percent by weight, from greater than 0.6 percent by weight, from greater than 0.7 percent by weight, and from greater than 0.8 percent by weight. In addition, the at least one fluorescer can be present in an amount ranging from 0.05 percent by weight to less than 0.9 percent by weight, based on the total weight of the two-part composition, such as from less than 0.8 percent by weight, from less than 0.7 percent by weight, from less than 0.6 percent by weight, from less than 0.5 percent by weight, from less than 0.4 percent by weight, from less than 0.3 percent by weight, from less than 0.2 percent by weight, and from less than 0.1 percent by weight. It is also intended that the amount of at least one fluorescer can range between any of the numerical values listed above.

Examples of the at least one peroxide useful in the present disclosure include hydrogen peroxide; sodium peroxide; sodium perborate; sodium pyrophosphate peroxide; urea peroxide; histidine peroxide; t-butyl-hydroperoxide; peroxybenzoic acid; and mixtures thereof. In certain embodiments, the at least one peroxide is present in an amount ranging from 0.25 percent to 25 percent by weight, based on the total weight of the two-part composition. For example, the at least one peroxide can be present in an amount ranging from 0.25 percent to 20 percent by weight, based on the total weight of the two-part composition, such as from 0.5 percent to 20 percent by weight, from 0.5 percent to 15 percent by weight, from 0.5 percent to 10 percent by weight, and from 0.5 percent to 6 percent by weight. In certain embodiments, the at least one peroxide of the present disclosure can be hydrogen peroxide.

Examples of the at least one catalyst useful in the present disclosure includes sodium salicylate; sodium-5-fluorosalicylate; sodium-5-chlorosalicylate; sodium-5-bromosalicylate; sodium trifluoroacetate; potassium salicylate; potassium pentachlorophenolate; lithium salicylate; lithium-3-chlorosalicylate; lithium-5-chlorosalicylate; lithium-3,5-dichlorosalicylate; lithium-3,5,6-trichlorosalicylate; lithium-2-chlorobenzoate; lithium-5-t-butylsalicylate; lithium trifluoroacetate; rubidium acetate; tetrabutylammonium salicylate; tetrabutylammonium tetrafluoborate; tetraethylammonium benzoate; tetrabutylammonium benzoate; tetrabutylammonium hexafluorophosphate; tetraethylammonium perchlorate; tetrabutylammonium perchlorate; tetraoctylammonium perchlorate; tetrabutylammonium-2,3,5-trichlorobenzoate; tetramethylammonium trifluoroacetate; magnesium salicylate; magnesium-5-t-butyl-salicylate; magnesium-3-chlorosalicylate; magnesium-3,5-dichloro-salicylate; magnesium-3,5,6-trichlorosalicylate; and mixtures thereof. In certain embodiments, the at least one catalyst is present in an amount ranging from 0.0005 percent to 0.5 percent by weight, based on the total weight of the two-part composition. For example, the at least one catalyst can be present in an amount ranging from greater than 0.0005 percent by weight to 0.5 percent by weight, based on the total weight of the two-part composition, such as from greater than 0.001 percent by weight, from greater than 0.005 percent by weight, from greater than 0.01 percent by weight, from greater than 0.05 percent by weight, from greater than 0.1 percent by weight, and from greater than 0.25 percent by weight. In addition, the at least one catalyst can be present in an amount ranging from 0.0005 percent by weight to less than 0.5 percent by weight, based on the total weight of the two-part composition, such as from less than 0.1 percent by weight, from less than 0.05 percent by weight, from less than 0.01 percent by weight, from less than 0.005 percent by weight, and from less than 0.001 percent by weight. It is also intended that the amount of at least one catalyst can range between any of the numerical values listed above.

Examples of the at least one carrier for the at least first part of the multiple-part marking system useful in the present disclosure include propylene glycol dialkyl ether containing one to three propylene moieties and each alkyl group is independently a straight-chain or branched-chain alkyl group containing up to 8 carbon atoms. Exemplary carriers for the first part of the multiple-part marking system include propylene glycol dialkyl ethers containing two propylene moieties such as dipropylene glycol dimethyl ether, dipropylene glycol diethyl ether, dipropylene glycol di-t-butyl ether, dibutyl phthalate, butyl benzoate, propylene glycol dibenzoate, ethyl-hexyl diphenyl phosphate, and mixtures thereof.

Examples of the at least one carrier for the at least one second part of the multiple-part marking system useful in the present disclosure include dimethyl phthalate, triethyl citrate, ethylene glycol dibenzoate, and mixtures thereof.

In certain embodiments, the at least one carrier is present in the at least first part and/or the at least one second part of the multiple-part marking system in an amount ranging from 5 percent to 95 percent by weight, based on the total weight of the two-part composition. For example, the at least one carrier can be present in an amount ranging from greater than 5 percent by weight to 95 percent by weight, based on the total weight of the two-part composition, such as from greater than 10 percent by weight, from greater than 20 percent by weight, from greater than 30 percent by weight, from greater than 40 percent by weight, from greater than 50 percent by weight, from greater than 60 percent by weight, from greater than 70 percent by weight, from greater than 80 percent by weight, and from greater than 90 percent by weight. In addition, the at least one carrier can be present in an amount ranging from 5 percent by weight to less than 95 percent by weight, based on the total weight of the two-part composition, such as from less than 90 percent by weight, from less than 80 percent by weight, from less than 70 percent by weight, from less than 60 percent by weight, from less than 50 percent by weight, from less than 40 percent by weight, from less than 30 percent by weight, from less than 20 percent by weight, and from less than 10 percent by weight. It is also intended that the amount of at least one carrier can range between any of the numerical values listed above.

The light of the signaling device may last approximately up to one hour. In certain embodiments, the signaling device of the present disclosure continues emitting light for at least one hour. This will enable the signaling device to emit light long enough as needed for the emergency or situation to be resolved. In addition, as the signaling devices can be safely and easily handled, they may be removed from the road or surface before the light goes out, or moved around after initial deployment, if so needed.

The peak intensity of the light emitted of the signaling device may reach approximately up to 9000 LUX, and in certain embodiments, the signaling device of the present disclosure may emit light at a peak intensity of at least 9000 LUX. This will allow the signaling device to be visible during all types of emergency situations, including, for example, on brightly lit city streets and additionally, on dark country roads.

As used herein, the light emitted by the marking system is measured using a light meter with a probe chosen dependant upon the light being emitted (infrared, visual, etc). For example, for light emission in the visible spectrum an irradiance probe is used. One of ordinary skill in the art would be well aware of how to select a probe suitable for measuring the wavelength of light the marking system has been designed to emit. The light emission is presented in LUX units.

The chemiluminescent system of the present disclosure can be contained in any suitable housing or container as part of the signaling device. In certain embodiments, the container separates the at least two parts of the marking system from interacting prior to the time marking is desired. In additional embodiments, the container can be comprised of hollow flexible tubing comprising therein a) at least one first solution comprised of at least one oxalate ester and at least one fluoresces; and b) at least one sealed glass vial comprising therein at least one second solution of at least one peroxide and at least one catalyst; wherein the at least one sealed glass vial can be comprised within the first solution inside the hollow flexible tubing, and wherein when the glass vial breaks the two parts can mix and react together. The flexible tubing can be sealed at both ends and can be comprised of an opaque or transparent plastic. The light can be generated when the flexible tubing is flexed, causing the glass vial inside to break, allowing mixing of the at least two solutions. Placing the marking system within flexible plastic tubing can act to prevent premature breaking of the glass vial and prevent premature mixing of the chemicals. As illustrated in FIG. 5, at least one first solution 41 is filled within the plastic tube 11 and caps 12 with at least one second solution 81 is sealed within the glass ampoule 61. In another embodiment, the location of the solutions are reversed.

FIG. 6 illustrates a signaling device with a self contained light source, with a reflector attached for improved visibility at night is activated and deployed. Wherein, the metal or plastic stand 15 is bent to create vertical supports to raise the self contained device from display surface.

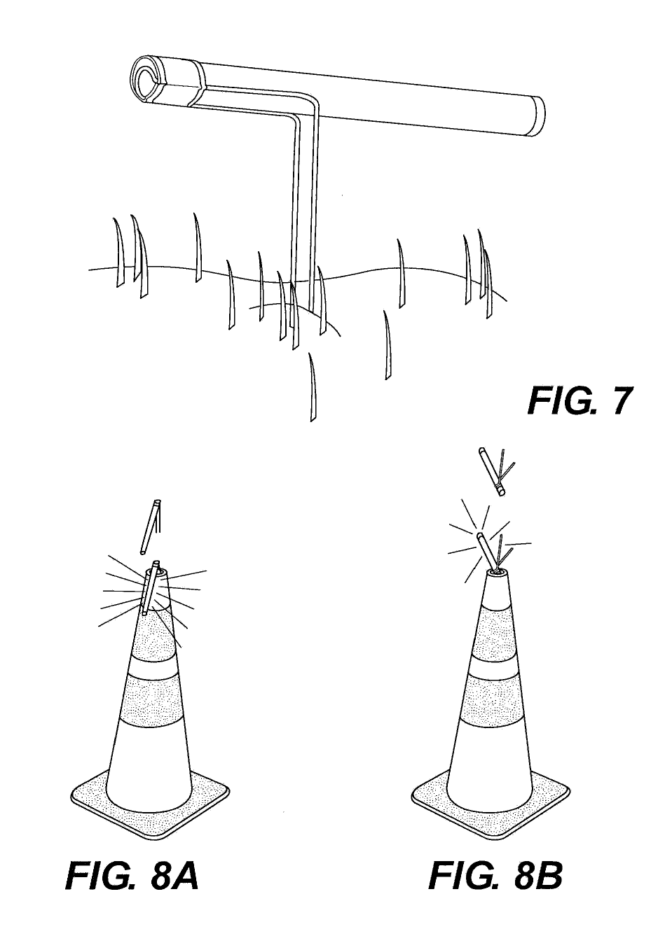

FIG. 7 illustrates the use of a signaling device with a self contained light source, and more particularly a chemiluminescent light source, with a reflector and stand 15 attached, displayed in a off road or soft ground situation, wherein the stand is used as a stake.

As shown in FIG. 8, a signaling device with a self contained light source, and with a reflector and stand attached is activated and deployed on a traffic cone. When mounted to a 36″ traffic cone, a chemiluminescent signaling device is proven to maximize visibility sighting, as shown in a test performed by Florida Gulf Coast University (ref. Evaluation of Chemical and Electric Flares; U.S. Justice Department: Doc. # 224277, Award # 2006-IJ-CX-K008). The signaling device can be, in one embodiment, deployed on the traffic cone, through use of the stand 15 such that it allow the device to be easily attached, either through configuration A or B.

FIG. 9 illustrates the use of a signaling device with a self contained light source, and more particularly a chemiluminescent light source, with a reflector and stand 15 attached, with a second device attached longitudinally via the use of the attachment feature 16. In one embodiment, the attachment feature allows the user to conjoin axially two chemiluminescent devices to double the length, light output, and height from ground of the signaling device, all which improve the effectiveness of the device.

In certain embodiments, a signaling device with a self contained chemiluminescent light source and a reflector attached for improved visibility will not have the drawbacks of the ignition based road flare, and will not spark or flame, can be safe for children and at the same time serious enough for militaries everywhere. Unlike chemiluminescent devices, ignition type flares which produce an open flame and burn more than 1000° F. are inherently dangerous, even to trained professionals which can be burned accidently.

A signaling device with a self contained chemiluminescent light source, is also a hermetically sealed device therein completely waterproof which allows the device to be used over and in water. In addition, even if the signaling device of the disclosure gets wet during storage, it will still perform for a shelf life of four years with no health or safety concerns.

A method of signaling is also disclosed herein, comprising the steps of deploying a signaling device comprising a multiple-part chemiluminescent system, wherein at least one first part comprising at least one oxalate ester and at least one fluorescer is separated by at least one breakable barrier from at least one second part comprising at least one peroxide and at least one catalyst; breaking the at least one barrier between the at least one first part and the at least one second part; generating light as a product of the reaction between the at least one first part and the at least one second part, bending down a stand, and placing the signaling device in a visible location, wherein a reflector attached to the signaling device will reflect the light of any oncoming light that hits the surface of the reflector.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A signaling device comprising a multi-part chemiluminescent light source and a reflective member attached to the signaling device, wherein the chemiluminescent light source comprises at least one first part comprising at least one oxalate ester and at least one fluorescer, and at least one second part comprising at least one peroxide and at least one catalyst.

2. The signaling device according to claim 1, wherein the at least one oxalate ester is chosen from bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2-nitrophenyl)oxalate; bis(2,4-dinitrophenyl)oxalate; bis(2,6-dichloro-4-nitrophenyl) oxalate; bis(2,4,6-trichlorophenyl)oxalate; bis(3-trifluoromethyl-4-nitrophenyl)oxalate; bis(2-methyl-4,6-dinitrophenyl)oxalate; bis(1,2-dimethyl-4,6-dinitrophenyl)oxalate; bis(2,4-dichlorophenyl)oxalate; bis(2,4-dinitrophenyl)oxalate; bis(2,5-dinitrophenyl)oxalate; bis(2-formyl-4-nitrophenyl)oxalate; bis(pentachlorophenyl)oxalate; bis(1,2-dihydro-2-oxo-1-pyridyl)glyoxal; bis(2,4-dinitro-6-methylphenyl)oxalate; bis-N-phthalimidyl oxalate.

3. The signaling device according to claim 1, wherein the at least one oxalate ester is present in an amount ranging from 3 percent to 60 percent by weight, based on the total weight of the two-part composition.

4. The signaling device according to claim 1, wherein the at least one fluorescer is chosen from 1-methoxy-9,10-bis(phenylethynyl)anthracene, perylene, rubrene, 16,17-didecycloxyviolanthrone, 2-ethyl-9,10-bis(phenylethynyl)anthracene; 2-chloro-9,10-bis(4-ethoxyphenyl)anthracene; 2-chloro-9,10-bis(4-methoxyphenyl)anthracene; 9,10-bis(phenylethynyl)anthracene; 1-chloro-9,10-bis(phenylethynyl)anthracene; 1,8-dichloro-9,10-bis(phenylethynyl)anthracene; 1,5-dichloro-9,10-bis(phenylethynyl)anthracene; 2,3-dichloro-9,10-bis(phenylethynyl)anthracene; 5,12-bis(phenylethynyl)tetracene; 9,10-diphenylanthracene; 1,6,7,12-tetraphenoxy-N,N′-bis(2,6-diisopropylphenyl)-3,4,9,10-perylene dicarboximide; 1,6,7,12-tetraphenoxy-N,N′-bis(2,5-di-t-butylphenyl)-3,4,9,10-perylene dicarboximide; 1,7-di-chloro-6,12-diphenoxy-N,N′-bis(2,6-diisopropylphenyl)-3,4,9,10-perylene dicarboximide; 1,6,7,12-tetra(p-bromophenoxy)-N,N′-bis(2,6-diisopropylphenyl)-3,4,9,10-perylene dicarboximide; 1,6,7,12-tetraphenoxy-N,N′-di-neopentyl-3,4,9,10-perylene dicarboximide; 1,6,7,12-tetra(p-t-butylphenoxy)N,N′-dineopentyl-3,4,9,10-perylene dicarboximide; 1,6,7,12-tetra(o-chlorophenoxy)-N,N′-bis(2,6-diisopropylphenyl)-3,4,9,10-perylene dicarboximide; 1,6,7,12-tetra(p-chlorophenoxy)-N,N′-bis(2,6-diisopropylphenyl)-3,4,9,10-perylene dicarboximide; 1,6,7,12-tetra(o-fluorophenoxy)-N,N′-bis(2,6-diisopropylphenyl)-3,4,9,10-perylene dicarboximide; 1,6,7,12-tetra(p-fluorophenoxy)-N,N′-bis(2,6-diisopropylphenyl)-3,4,9,10-perylene dicarboximide; 1,6,7,12-tetraphenoxy-N,N′-diethyl-3,4,9,10-perylene dicarboximide; 1,7-dibromo-6,12-diphenoxy-N,N′-bis(2-isopropylphenyl)-3,4,9,10-perylene dicarboximide; 16,17-dihexyloxyviolanthrone; rubrene; 1,4-dimethyl-9,10-bis(phenylethynyl)anthracene.

5. The signaling device according to claim 1, wherein the at least one fluorescer is present in an amount ranging from 0.05 percent to 0.9 percent by weight, based on the total weight of the two-part composition.

6. The signaling device according to claim 1, wherein the at least one peroxide is chosen from hydrogen peroxide; sodium peroxide; sodium perborate; sodium pyrophosphate peroxide; urea peroxide; histidine peroxide; t-butyl-hydroperoxide; and peroxybenzoic acid.

7. The signaling device according to claim 1, wherein the at least one peroxide is present in an amount ranging from 0.25 percent to 25 percent by weight, based on the total weight of the two-part composition.

8. The signaling device according to claim 1, wherein the at least one catalyst is chosen from sodium salicylate; sodium-5-fluorosalicylate; sodium-5-chlorosalicylate; sodium-5-bromosalicylate; sodium trifluoroacetate; potassium salicylate; potassium pentachlorophenolate; lithium salicylate; lithium-3-chlorosalicylate; lithium-5-chlorosalicylate; lithium-3,5-dichlorosalicylate; lithium-3,5,6-trichlorosalicylate; lithium-2-chlorobenzoate; lithium-5-t-butylsalicylate, lithium trifluoroacetate; rubidium acetate; tetrabutylammonium salicylate; tetrabutylammonium tetrafluoborate; tetraethylammonium benzoate; tetrabutylammonium benzoate; tetrabutylammonium hexafluorophosphate; tetraethylammonium perchlorate; tetrabutylammonium perchlorate; tetraoctylammonium perchlorate; tetrabutylammonium-2,3,5-trichlorobenzoate; tetramethylammonium trifluoroacetate; magnesium salicylate; magnesium-5-t-butyl-salicylate; magnesium-3-chlorosalicylate; magnesium-3,5-dichloro-salicylate; magnesium-3,5,6-trichlorosalicylate.

9. The signaling device according to claim 1, wherein the at least one catalyst is present in an amount ranging from 0.0005 percent to 0.5 percent by weight, based on the total weight of the two-part composition.

10. The signaling device according to claim 1 further comprising at least one carrier present in an amount ranging from 5 percent to 95 percent by weight, based on the total weight of the two-part composition.

11. A signaling device comprising a multi-part chemiluminescent light source and a stand attached to the signaling device, wherein the chemiluminescent light source comprises at least one first part comprising at least one oxalate ester and at least one fluorescer, and at least one second part comprising at least one peroxide and at least one catalyst.

12. A signaling device according to claim 11, wherein the stand is attached longitudinally.

13. A signaling device according to claim 11, wherein the at least one oxalate ester (i) is present in an amount ranging from 3 percent to 60 percent by weight, based on the total weight of the two-part composition, and (ii) is chosen from bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2-nitrophenyl)oxalate; bis(2,4-dinitrophenyl)oxalate; bis(2,6-dichloro-4-nitrophenyl)oxalate; bis(2,4,6-trichlorophenyl)oxalate; bis(3-trifluoromethyl-4-nitrophenyl)oxalate; bis(2-methyl-4,6-dinitrophenyl)oxalate; bis(1,2-dimethyl-4,6-dinitrophenyl)oxalate; bis(2,4-dichlorophenyl)oxalate; bis(2,4-dinitrophenyl)oxalate; bis(2,5-dinitrophenyl)oxalate; bis(2-formyl-4-nitrophenyl)oxalate; bis(pentachlorophenyl)oxalate; bis(1,2-dihydro-2-oxo-1-pyridyl)glyoxal; bis(2,4-dinitro-6-methylphenyl)oxalate; bis-N-phthalimidyl oxalate,
wherein the at least one fluorescer (i) is present in an amount ranging from 0.05 percent to 0.9 percent by weight, based on the total weight of the two-part composition, and (ii) is chosen from 1-methoxy-9,10-bis(phenylethynyl)anthracene, perylene, rubrene, 16,17-didecycloxyviolanthrone, 2-ethyl-9,10-bis(phenylethynyl)anthracene; 2-chloro-9,10-bis(4-ethoxyphenyl)anthracene; 2-chloro-9,10-bis(4-methoxyphenyl)anthracene; 9,10-bis(phenylethynyl)anthracene; 1-chloro-9,10-bis(phenylethynyl)anthracene; 1,8-dichloro-9,10-bis(phenylethynyl)anthracene; 1,5-dichloro-9,10-bis(phenylethynyl)anthracene; 2,3-dichloro-9,10-bis(phenylethynyl)anthracene; 5,12-bis(phenylethynyl)tetracene; 9,10-diphenylanthracene; 1,6,7,12-tetraphenoxy-N,N′-bis(2,6-diisopropylphenyl)-3,4,9,10-perylene dicarboximide; 1,6,7,12-tetraphenoxy-N N′-bis(2,5-di-t-butylphenyl)-3,4,9,10-perylene dicarboximide; 1,7-di-chloro-6,12-diphenoxy-N,N′-bis(2,6-diisopropylphenyl)-3,4,9,10-perylene dicarboximide; 1,6,7,12-tetra(p-bromophenoxy)-N,N′-bis(2,6-diisopropylphenyl)-3,4,9,10-perylene dicarboximide; 1,6,7,12-tetraphenoxy-N,N′-di-neopentyl-3,4,9,10-perylene dicarboximide; 1,6,7,12-tetra(p-t-butylphenoxy)N,N′-dineopentyl-3,4,9,10-perylene dicarboximide; 1,6,7,12-tetra(o-chlorophenoxy)-N,N′-bis(2,6-diisopropylphenyl)-3,4,9,10-perylene dicarboximide; 1,6,7,12-tetra(p-chlorophenoxy)-N,N′-bis(2,6-diisopropylphenyl)-3,4,9,10-perylene dicarboximide; 1,6,7,12-tetra(o-fluorophenoxy)-N,N′-bis(2,6-diisopropylphenyl)-3,4,9,10-perylene dicarboximide; 1,6,7,12-tetra(p-fluorophenoxy)-N N′ bis(2,6-diisopropylphenyl)-3,4,9,10-perylene dicarboximide; 1,6,7,12-tetraphenoxy-N,N′-diethyl-3,4,9,10-perylene dicarboximide; 1,7-dibromo-6,12-diphenoxy-N,N′-bis(2-isopropylphenyl)-3,4,9,10-perylene dicarboximide; 16,17-dihexyloxyviolanthrone; rubrene; 1,4-dimethyl-9,10-bis(phenylethynyl)anthracene,
wherein the at least one peroxide (i) is present in an amount ranging from 0.25 percent to 25 percent by weight, based on the total weight of the two-part composition, and (ii) is chosen from hydrogen peroxide; sodium peroxide; sodium perborate; sodium pyrophosphate peroxide; urea peroxide; histidine peroxide; t-butyl-hydroperoxide; and peroxybenzoic acid, and
wherein the at least one catalyst (i) is present in an amount ranging from 0.0005 percent to 0.5 percent by weight, based on the total weight of the two-part composition, and (ii) is chosen from sodium salicylate; sodium-5-fluorosalicylate; sodium-5-chlorosalicylate; sodium-5-bromosalicylate; sodium trifluoroacetate; potassium salicylate; potassium pentachlorophenolate; lithium salicylate; lithium-3-chlorosalicylate; lithium-5-chlorosalicylate; lithium-3,5-dichlorosalicylate; lithium-3,5,6-trichlorosalicylate; lithium-2-chlorobenzoate; lithium-5-t-butylsalicylate; lithium trifluoroacetate; rubidium acetate; tetrabutylammonium salicylate; tetrabutylammonium tetrafluoborate; tetraethylammonium benzoate; tetrabutylammonium benzoate; tetrabutylammonium hexafluorophosphate; tetraethylammonium perchlorate; tetrabutylammonium perchlorate; tetraoctylammonium perchlorate; tetrabutylammonium-2,3,5-trichlorobenzoate; tetramethylammonium trifluoroacetate; magnesium salicylate; magnesium-5-t-butyl-salicylate; magnesium-3-chlorosalicylate; magnesium-3,5-dichloro-salicylate; magnesium-3,5,6-trichlorosalicylate.

14. A signaling device comprising a multi-part chemiluminescent light source, a reflective member attached to the signaling device, a stand attached to the signaling device, and an attachment member,
wherein the attachment member allows another signaling device to be attached thereto, and wherein the chemiluminescent light source comprises at least one first part comprising at least one oxalate ester and at least one fluorescer, and at least one second part comprising at least one peroxide and at least one catalyst.

15. A signaling device according to claim 11, wherein the at least one oxalate ester (i) is present in an amount ranging from 3 percent to 60 percent by weight, based on the total weight of the two-part composition, and (ii) is chosen from bis(2,4,5-trichloro-6-carbopentoxyphenyl)oxalate; bis(2,4,5-trichlorophenyl)oxalate; bis(2,4,5-tribromo-6-carbohexoxyphenyl)oxalate; bis(2-nitrophenyl)oxalate; bis(2,4-dinitrophenyl)oxalate; bis(2,6-dichloro-4-nitrophenyl)oxalate; bis(2,4,6-trichlorophenyl)oxalate; bis(3-trifluoromethyl-4-nitrophenyl)oxalate; bis(2-methyl-4,6-dinitrophenyl)oxalate; bis(1,2-dimethyl-4,6-dinitrophenyl)oxalate; bis(2,4-dichlorophenyl)oxalate; bis(2,4-dinitrophenyl)oxalate; bis(2,5-dinitrophenyl)oxalate; bis(2-formyl-4-nitrophenyl)oxalate; bis(pentachlorophenyl)oxalate; bis(1,2-dihydro-2-oxo-1-pyridyl)glyoxal; bis(2,4-dinitro-6-methylphenyl)oxalate; bis-N-phthalimidyl oxalate,
wherein the at least one fluorescer (i) is present in an amount ranging from 0.05 percent to 0.9 percent by weight, based on the total weight of the two-part composition, and (ii) is chosen from 1-methoxy-9,10-bis(phenylethynyl)anthracene, perylene, rubrene, 16,17-didecycloxyviolanthrone, 2-ethyl-9,10-bis(phenylethynyl)anthracene; 2-chloro-9,10-bis(4-ethoxyphenyl)anthracene; 2-chloro-9,10-bis(4-methoxyphenyl)anthracene; 9,10-bis(phenylethynyl)anthracene; 1-chloro-9,10-bis(phenylethynyl)anthracene; 1,8-dichloro-9,10-bis(phenylethynyl)anthracene; 1,5-dichloro-9,10-bis(phenylethynyl)anthracene; 2,3-dichloro-9,10-bis(phenylethynyl)anthracene; 5,12-bis(phenylethynyl)tetracene; 9,10-diphenylanthracene; 1,6,7,12-tetraphenoxy-N,N′-bis(2,6-diisopropylphenyl)-3,4,9,10-perylene dicarboximide; 1,6,7,12-tetraphenoxy-N,N′-bis(2,5-di-t-butylphenyl)-3,4,9,10-perylene dicarboximide; 1,7-di-chloro-6,12-diphenoxy-N,N′-bis(2,6-diisopropylphenyl)-3,4,9,10-perylene dicarboximide; 1,6,7,12-tetra(p-bromophenoxy)-N,N′-bis(2,6-diisopropylphenyl)-3,4,9,10-perylene dicarboximide; 1,6,7,12-tetraphenoxy-N,N′-di-neopentyl-3,4,9,10-perylene dicarboximide; 1,6,7,12-tetra(p-t-butylphenoxy)N,N′-dineopentyl-3,4,9,10-perylene dicarboximide; 1,6,7,12-tetra(o-chlorophenoxy)-N,N′-bis(2,6-diisopropylphenyl)-3,4,9,10-perylene dicarboximide; 1,6,7,12-tetra(p-chlorophenoxy)-N,N′-bis(2,6-diisopropylphenyl)-3,4,9,10-perylene dicarboximide; 1,6,7,12-tetra(o-fluorophenoxy)-N,N′-bis(2,6-diisopropylphenyl)-3,4,9,10-perylene dicarboximide; 1,6,7,12-tetra(p-fluorophenoxy)-N,N′ bis(2,6-diisopropylphenyl)-3,4,9,10-perylene dicarboximide; 1,6,7,12-tetraphenoxy-N,N′-diethyl-3,4,9,10-perylene dicarboximide; 1,7-dibromo-6,12-diphenoxy-N,N′-bis(2-isopropylphenyl)-3,4,9,10-perylene dicarboximide; 16,17-dihexyloxyviolanthrone; rubrene; 1,4-dimethyl-9,10-bis(phenylethynyl)anthracene,
wherein the at least one peroxide (i) is present in an amount ranging from 0.25 percent to 25 percent by weight, based on the total weight of the two-part composition, and (ii) is chosen from hydrogen peroxide; sodium peroxide; sodium perborate; sodium pyrophosphate peroxide; urea peroxide; histidine peroxide; t-butyl-hydroperoxide; and peroxybenzoic acid, and
wherein the at least one catalyst (i) is present in an amount ranging from 0.0005 percent to 0.5 percent by weight, based on the total weight of the two-part composition, and (ii) is chosen from sodium salicylate; sodium-5-fluorosalicylate; sodium-5-chlorosalicylate; sodium-5-bromosalicylate; sodium trifluoroacetate; potassium salicylate; potassium pentachlorophenolate; lithium salicylate; lithium-3-chlorosalicylate; lithium-5-chlorosalicylate; lithium-3,5-dichlorosalicylate; lithium-3,5,6-trichlorosalicylate; lithium-2-chlorobenzoate; lithium-5-t-butylsalicylate; lithium trifluoroacetate; rubidium acetate; tetrabutylammonium salicylate; tetrabutylammonium tetrafluoborate; tetraethylammonium benzoate; tetrabutylammonium benzoate; tetrabutylammonium hexafluorophosphate; tetraethylammonium perchlorate; tetrabutylammonium perchlorate; tetraoctylammonium perchlorate; tetrabutylammonium-2,3,5-trichlorobenzoate; tetramethylammonium trifluoroacetate; magnesium salicylate; magnesium-5-t-butyl-salicylate; magnesium-3-chlorosalicylate; magnesium-3,5-dichloro-salicylate; magnesium-3,5,6-trichlorosalicylate.
